(19) United States
(12) Patent Application Publication
(10) Pub. No.: US 2015/0241663 A1
(43) Pub. Date: Aug. 27, 2015

(54) OPTICAL FOCUSING SYSTEM

(71) Applicant: Union Optech Co., Ltd., Zhongshan (CN)

(72) Inventor: Junqiang GONG, Zhongshan (CN)

(21) Appl. No.: 14/621,363

(22) Filed: Feb. 12, 2015

(30) Foreign Application Priority Data
Feb. 22, 2014 (CN) 201410063263.7

(51) Int. Cl. G02B 13/00; G03B 3/00

(52) U.S. Cl. CPC G02B 13/0045; G03B 3/00

(57) ABSTRACT

An optical focusing system, including a focusing lens group, a fixed lens group, and an imaging surface. The focusing lens group is disposed at a forefront of an object space, or a rearmost of an image space, or between lenses of the fixed lens group.

### CROSS-REFERENCE TO RELATED APPLICATIONS

Pursuant to 35 U.S.C. §119 and the Paris Convention Treaty, this application claims the benefit of Chinese Patent Application No. 201410063263.7 filed Feb. 22, 2014, the contents of which are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to an optical focusing system.

2. Description of the Related Art

When photographing objects at a short or long distance, conventional camera lenses need to move as a whole for a long distance when focusing. For example, when the camera lens is applied to a high definition video monitoring at a wide angle, the focusing distance is greater than 0.5 mm, which causes a long focusing time and fuzzy pictures. When the camera lens is applied to smartphones, the focusing distance is between 0.2 and 0.5 mm, which requires large size of focusing components in the smartphones thereby increasing the thickness of the phones and reducing the focusing accuracy.

### SUMMARY OF THE INVENTION

In view of the above-described problems, it is one objective of the invention to provide an optical focusing system that is thin, lightweight, and highly practicable. The optical focusing system features high definition focusing and can be applied to a camera of a smartphone and high definition video monitoring.

To achieve the above objective, in accordance with one embodiment of the invention, there is provided an optical focusing system, comprising a focusing lens group, a fixed lens group, and an imaging surface. The focusing lens group is disposed at a forefront of an object space, or a rearmost of an image space, or between lenses of the fixed lens group.

In a class of this embodiment, the focusing lens group and the fixed lens group comprise spherical lens or nonspherical lens.

In a class of this embodiment, an optical filter is disposed in front of the imaging surface and faces the object face.

In a class of this embodiment, the focusing lens group comprises one or more lenses.

In a class of this embodiment, the fixed lens group comprises one or more lenses.

Advantages according to embodiments of the invention are summarized as follows:

1. The moving distance of the lens of the optical focusing system is within 0.10 mm for focusing.

2. The optical focusing system can be applied to a monitoring camera for fast focusing and high definition imaging.

3. The optical focusing system can be applied to a smartphone thereby achieving thin appearance and accurate focusing thereof.

### DESCRIPTION OF THE DRAWINGS

The invention is described hereinbelow with reference to the accompanying drawings, in which:

FIG. 1 is a structure diagram of an optical focusing system in accordance with Example 1;

FIG. 2 is a structure diagram of an optical focusing system in accordance with Example 2;

FIG. 3 is a structure diagram of an optical focusing system in accordance with Example 3; and

FIG. 4 is a structure diagram of an optical focusing system in accordance with Example 4.

### DETAILED DESCRIPTION OF THE EMBODIMENTS

For further illustrating the invention, experiments detailing an optical focusing system are described below. It should be noted that the following examples are intended to describe and not to limit the invention.

### Example 1

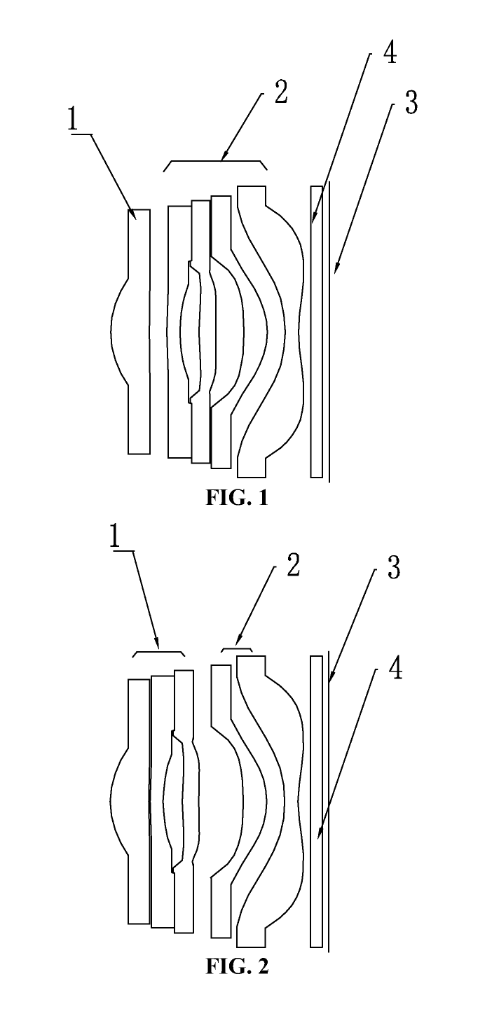

As shown in FIG. 1, an optical focusing system comprises a focusing lens group 1, a fixed lens group 2 and an imaging surface 3. The focusing lens group 1 is disposed at the front of the optical focusing system and is close to the object, that is, the focusing lens group 1 faces the object space. The focusing lens group 1 comprises only one lens, and the fixed lens group 2 comprises a plurality of lenses. When photographing long distance objects, the fixed lens group is fixed, and the focusing lens group 1 moves toward the fixed lens group 2 until a clear image is obtained. Vice versa, when photographing short distance objects, the fixed lens group is fixed, and the focusing lens group 1 moves away from the fixed lens group 2 until a clear image is obtained.

### Example 2

As shown in FIG. 2, an optical focusing system comprises a focusing lens group 1, a fixed lens group 2 and an imaging surface 3. The focusing lens group 1 is disposed at the front of the optical focusing system and is close to the object, that is, the focusing lens group 1 faces the object space. The focusing lens group 1 comprises a plurality of lenses, and the fixed lens group 2 also comprises a plurality of lenses. When photographing long distance objects, the fixed lens group is fixed, and the focusing lens group 1 moves toward the fixed lens group 2 until a clear image is obtained. Vice versa, when photographing short distance objects, the fixed lens group is fixed, and the focusing lens group 1 moves away from the fixed lens group 2 until a clear image is obtained.

### Example 3

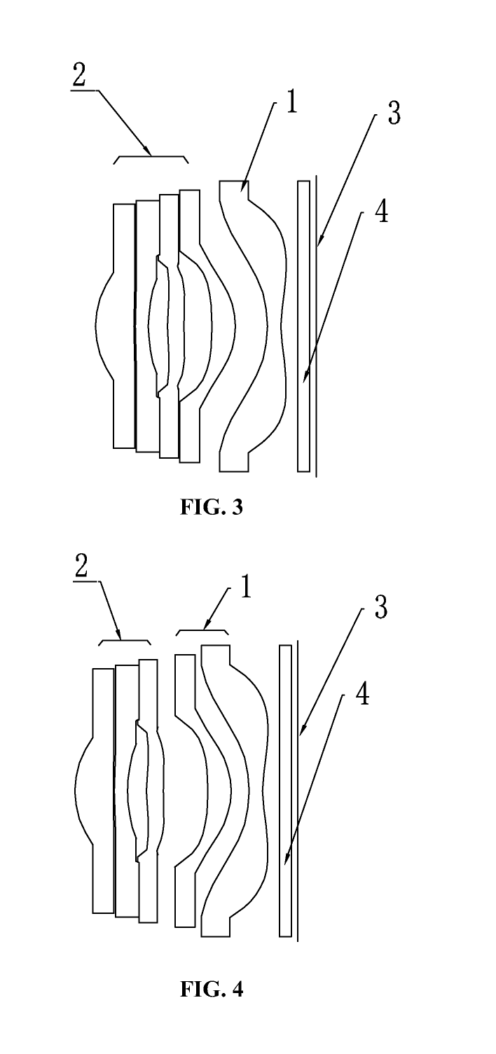

As shown in FIG. 3, an optical focusing system comprises a focusing lens group 1, a fixed lens group 2 and an imaging surface 3. The focusing lens group 1 is disposed at the rear of the optical focusing system and is close to the imaging surface 3, that is, the focusing lens group 1 faces the image space. The focusing lens group 1 comprises only one lens, and the fixed lens group 2 comprises a plurality of lenses. When photographing long distance objects, the fixed lens group is fixed, and the focusing lens group 1 moves toward the fixed lens group 2 until a clear image is obtained. Vice versa, when photographing short distance objects, the fixed lens group is fixed, and the focusing lens group 1 moves away from the fixed lens group 2 until a clear image is obtained.

### Example 4

As shown in FIG. 4, an optical focusing system comprises a focusing lens group 1, a fixed lens group 2 and an imaging surface 3. The focusing lens group 1 is disposed at the rear of the optical focusing system and is close to the imaging surface 3, that is, the focusing lens group 1 faces the image space. The focusing lens group 1 comprises a plurality of lenses, and the fixed lens group 2 also comprises a plurality of lenses. When photographing long distance objects, the fixed lens group is fixed, and the focusing lens group 1 moves toward the fixed lens group 2 until a clear image is obtained. Vice versa, when photographing short distance objects, the fixed lens group is fixed, and the focusing lens group 1 moves away from the fixed lens group 2 until a clear image is obtained.

Optionally, the focusing lens group can be disposed between lenses of the fixed lens group.

In the optical focusing system, an optical filter 4 is disposed in front of the imaging surface 3 and faces the object face. The focusing lens group 1 and the fixed lens group 2 comprise spherical lens or nonspherical lens.

The optical focusing system of the invention features short focusing distant, quick and accurate high definition focusing, small size, and a wide range of practicality.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An optical focusing system, comprising:
a) a focusing lens group;
b) a fixed lens group; and
c) an imaging surface;
wherein the focusing lens group is disposed at a forefront of an object space, or a rearmost of an image space, or between lenses of the fixed lens group.

2. The system of claim 1, wherein the focusing lens group and the fixed lens group comprise spherical lens or nonspherical lens.

3. The system of claim 2, wherein an optical filter is disposed in front of the imaging surface and faces the object face.

4. The system of claim 2, wherein the focusing lens group comprises one or more lenses.

5. The system of claim 2, wherein the fixed lens group comprises one or more lenses.
